(19) United States
(12) Patent Application Publication
(10) Pub. No.: US 2018/0143420 A1
(43) Pub. Date: May 24, 2018

(54) SCOPE VIEWING APPARATUS

(71) Applicant: Alexander Ellis, Calhoun City, MS (US)

(72) Inventor: Alexander Ellis, Calhoun City, MS (US)

(21) Appl. No.: 15/819,464

(22) Filed: Nov. 21, 2017

Related U.S. Application Data
(60) Provisional application No. 62/425,349, filed on Nov. 22, 2016.

(51) Int. Cl. G02B 23/16; G02B 23/00; G02B 7/04

(52) U.S. Cl. CPC G02B 23/16; G02B 7/04; G02B 23/145

(57) ABSTRACT

An apparatus for projecting the view of a spotting scope onto a device is provided. The scope viewing apparatus includes a frame having a first side and a second side, the first side of the frame including mounting brackets and synchronizing blocks, wherein the synchronizing blocks lay atop the mounting brackets. The second side of the frame comprises opposing arm members perpendicularly protruding from the second side of the frame, where the opposing arm members are configured to receive a spotting scope therebetween. An interior of the synchronizing blocks is configured to slidably receive a device into an interior of the mounting brackets such that a lens of the device is aligned with an eyepiece of the spotting scope.

### CROSS REFERENCE TO RELATED APPLICATION

This application claims the benefit of U.S. Provisional Application No. 62/425,349 filed on Nov. 22, 2016. The above identified patent application is herein incorporated by reference in its entirety to provide continuity of disclosure.

### FIELD OF THE INVENTION

The present disclosure relates to magnification devices with flatboard assemblies. More specifically, the present disclosure provides combination spotting scopes and corresponding frame assemblies.

### BACKGROUND OF THE INVENTION

A demand for improved device magnification has developed with the development of a variety of hand-held devices and tablets, including but not limited to, Apple Inc.'s IPAD® devices (from Apple Inc. of Cupertino, Calif.), Android™ operating system from Google Inc. (from Google Inc. of Mountain View, Calif.), and the like. These devices typically have a varying degree of pixels and capabilities, such as “zooming-in/out” to improve the magnification of an object. With each device update, a new “generation” is released that has improved magnification abilities. For example, a second-generation iPad has improved pixel resolutions and improved “zooming-in/out” capabilities when compared with a preceding first generation.

Unfortunately, even with each device's improved magnification ability, there is still demand for magnification improvement. The demand relies on the release of an updated device “generation.” Many people make an effort to supplement magnification with external devices.

### SUMMARY OF THE INVENTION

Therefore, disclosed herein is an apparatus configured to synchronize a device with increased magnification, such as a spotting scope, with another device, such as a tablet, such that the apparatus can provide an enlarged view of an image in the spotting scope's view on a display of an electronic device.

In view of the foregoing, disclosed herein is a scope viewing apparatus comprising a frame comprising a first side and a second side. The first side of the frame comprises mounting brackets and synchronizing blocks, wherein the synchronizing blocks lay atop the mounting brackets. The second side of the frame comprises opposing arm members perpendicularly protruding from the second side of the frame, wherein the opposing arm members are configured to receive a spotting scope therebetween. Moreover, an interior of the synchronizing blocks is configured to slidably receive a device into an interior of the mounting brackets such that a lens of the device is aligned with an eyepiece of the spotting scope.

It is another object of the present disclosure to provide at least one base to which the frame and the opposing arm members attach.

It is another object of the present disclosure to provide the synchronizing blocks laying atop the mounting brackets such that the interior of the mounting brackets and the interior of the synchronizing blocks form a channel.

It is yet another object of the present disclosure to provide a frame comprising at least one aperture adjacent at least one corner of the frame.

Yet another object of the present disclosure is to provide the opposing arm members mounted to the second side of frame.

Another object of the present disclosure is to provide the two opposing arm members protruding perpendicularly at a perpendicular orientation relative to the mounting brackets.

Another object of the present disclosure is to provide at least one of the opposing arm members comprising at least one groove.

Yet another object of the present disclosure is to provide at least one brace attached to at least one of the opposing arm members.

Another object of the present disclosure is to provide at least one of the opposing arm members comprising at least one handle extending along a side of the at least one opposing arm members.

Yet another object of the present disclosure is to provide at least one of the opposing arm members comprises at least one aperture extending along a bottom corner of the at least one opposing arm members. The present disclosure may be readily fabricated from materials that permit relative economy and are commensurate with durability.

Also disclosed herein is a scope viewing apparatus comprising a frame comprising a first side and a second side; the first side of the frame comprises mounting brackets and synchronizing blocks, where the synchronizing blocks lay atop the mounting brackets; the second side of the frame comprises opposing arm members perpendicularly protruding from the second side of the frame; and a spotting scope between the opposing arm members. Moreover, an interior of the synchronizing blocks slidably receives a device into an interior of the mounting brackets such that a lens of the device is aligned with an eyepiece of the spotting scope.

Another object of the present disclosure is to provide the spotting scope comprising at least one magnification dial and at least one focus adjustment dial.

### BRIEF DESCRIPTIONS OF THE DRAWINGS

Although the characteristic features of this disclosure will be particularly pointed out in the claims, the disclosure itself and manner in which it may be made and used may be better understood after a review of the following description, taken in connection with the accompanying drawings wherein like numeral annotations are provided throughout.

FIG. 1 shows a perspective view of a working example of the scope viewing apparatus.

FIG. 2 shows a side view of a working example of the scope viewing apparatus.

FIG. 3 shows a rear view of a working example of the scope viewing apparatus.

FIG. 4 shows an underside view of a working example of the scope viewing apparatus.

FIG. 5 shows a left side view of a working example of the scope viewing apparatus.

FIG. 6 shows a right side view of a working example of the scope viewing apparatus.

### DETAILED DESCRIPTION OF THE INVENTION

Reference is made herein to the attached drawings. Like reference numerals are used throughout the drawings to depict like or similar elements of the scope viewing apparatus. For the purposes of presenting a brief and clear description of the present invention, the preferred embodiment will be discussed as used for a spotting scope and corresponding frame assembly. The figures are intended for representative purposes only and should not be considered to be limiting in any respect.

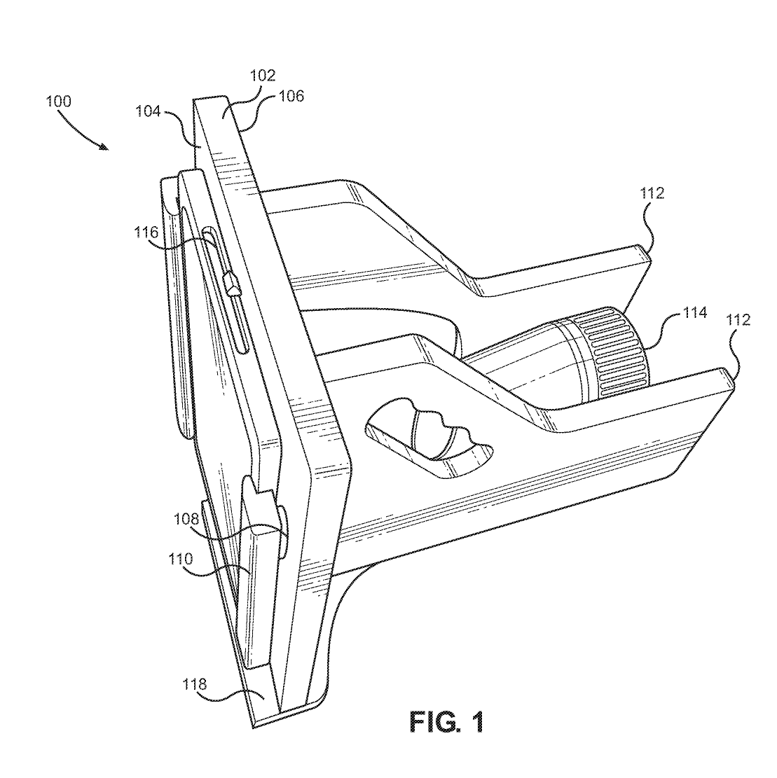

Referring to FIGS. 1-3, there is shown a perspective, side, and rear view of the scope viewing apparatus according to one embodiment of the present disclosure. The scope viewing apparatus 100 comprises a frame 102 that comprises a first side 104 and a second side 106. The frame 102 may be made of any sturdy material and be any structure compatible with opposing arm members 112, such as, for example, a flatboard.

The first side 104 of the frame 102 comprises mounting brackets 108 and synchronizing blocks 110. The mounting brackets 108 extend from the first side 104 of the frame 102. The mounting brackets 108 are configured to hold the device 116 along the same plane as frame 102. For example, there may be mounting brackets 108 positioned at each corner of the device 116. The mounting brackets 108 also hold the device 116 relative to a spotting scope 114.

Moreover, the synchronizing blocks 110 may lay atop the mounting brackets 108. Alternatively, the synchronizing blocks 110 may lay atop the mounting brackets 108 such that they are permanently affixed. Thus, the mounting brackets 108 and the synchronizing blocks 110 may be any structure and have any shape compatible with one another, as well as being compatible to receive the device 116. The synchronizing blocks 110 are also configured to hold the device 116, such as, for example, a Galaxy tablet along the same plane as frame 102. For example, there may be synchronizing blocks 110 positioned at each corner of the device 116.

The second side 106 of the frame 102 comprises opposing arm members 112 perpendicularly protruding from the second side 106. The opposing arm members 112 are mounted to the second side 106 of frame 102. The opposing arm members 112 are also configured to receive the spotting scope 114 therebetween, such that the view of the spotting scope 114 can be projected onto the device 116. The opposing arm members 112 are aligned with one another and oriented such that when the spotting scope 114 is positioned therebetween, the spotting scope 114 lens is aligned with the lens of the device 114. That is, the center of the lens of device 116 is aligned with the center of the lens of the spotting scope 114. For example, an interior of the synchronizing blocks 110 may slidably receive the device 114 into an interior of the mounting brackets 108, such that the lens of the device 114 is aligned with (i.e. sits behind) an eyepiece of the spotting scope 114. In addition, when the synchronizing blocks 110 lay atop the mounting brackets 108, a channel may be formed therebetween. For example, an interior of the synchronizing blocks 110 and an interior of the mounting brackets 108 form a channel. In view of the foregoing, the scope viewing apparatus 100 can provide an enlarged view of an image in the spotting scope 114's view and improves visibility for those who have difficulty looking through the eyepiece the spotting scope 114.

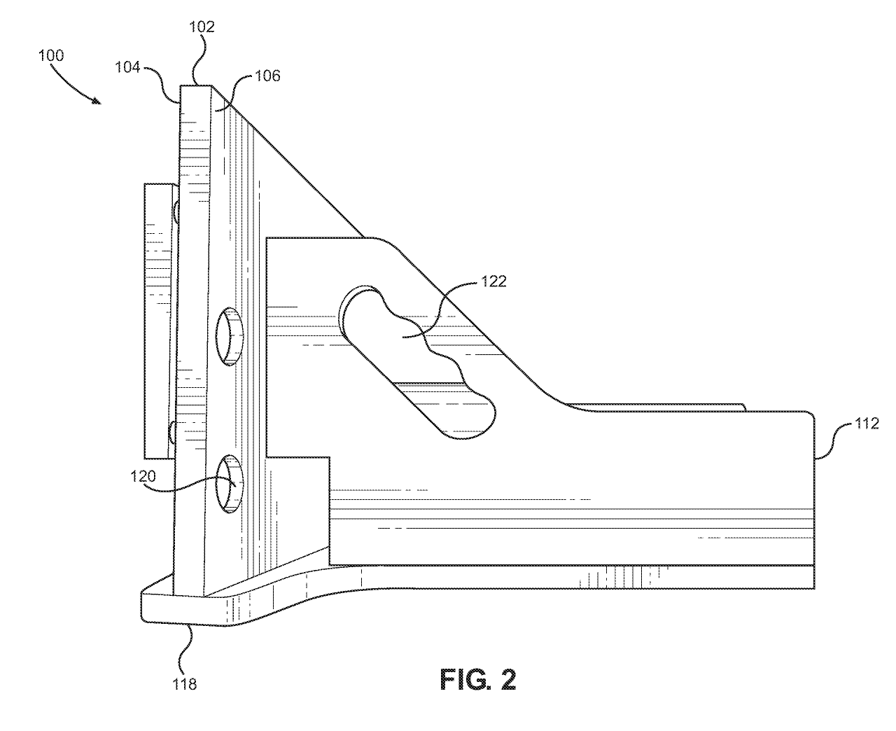

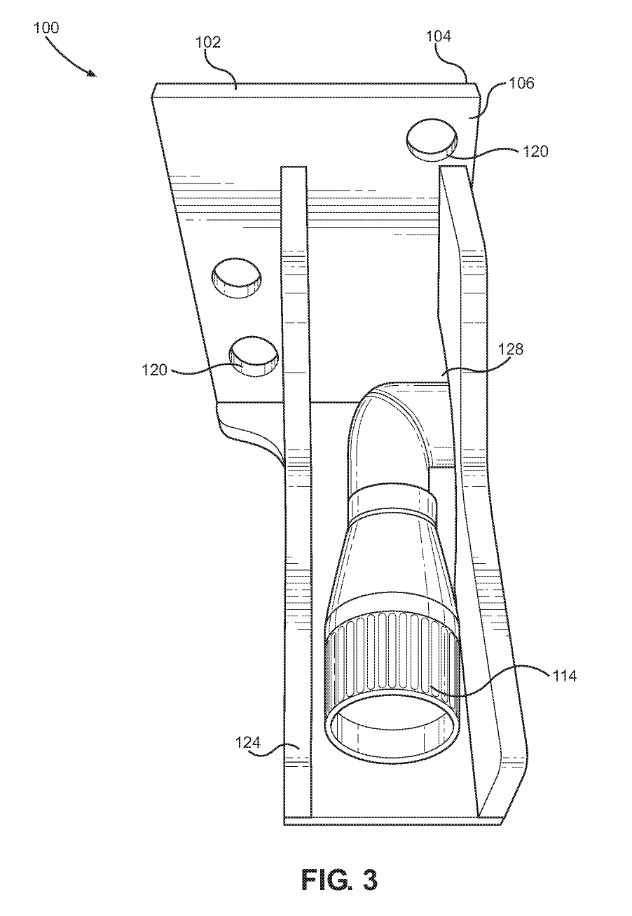

As shown in FIG. 2, the frame 102 comprises at least one aperture 120 adjacent at least one corner of the frame 102. However, the at least one aperture 120 is not limited to the at least one corner of the frame 102 and can may be positioned anywhere along the plane of the second side 106. Additionally, at least one of the opposing arm members 112 comprises at least one groove 124, as shown in FIG. 3. The at least one groove 124 may be positioned at a corner of the at least one of the opposing arm members 112. However, the at least one groove 124 is not limited to the at least one corner of the opposing arm members 112 and may be positioned anywhere along the plane of the opposing arm members 112.

Moreover, the at least one of the opposing arm members 112 comprises at least one handle 122 extending along a side of the at least one opposing arm members, also shown in FIG. 2. There is no limit as to how long/short the at least one handle 122 may extend. The at least one handle 122 may act as a handle bar through which a user may place the user's hand when carrying or transporting the scope viewing apparatus 100. The at least one handle 122 border may have a series of perforations along its perimeter or may be smooth.

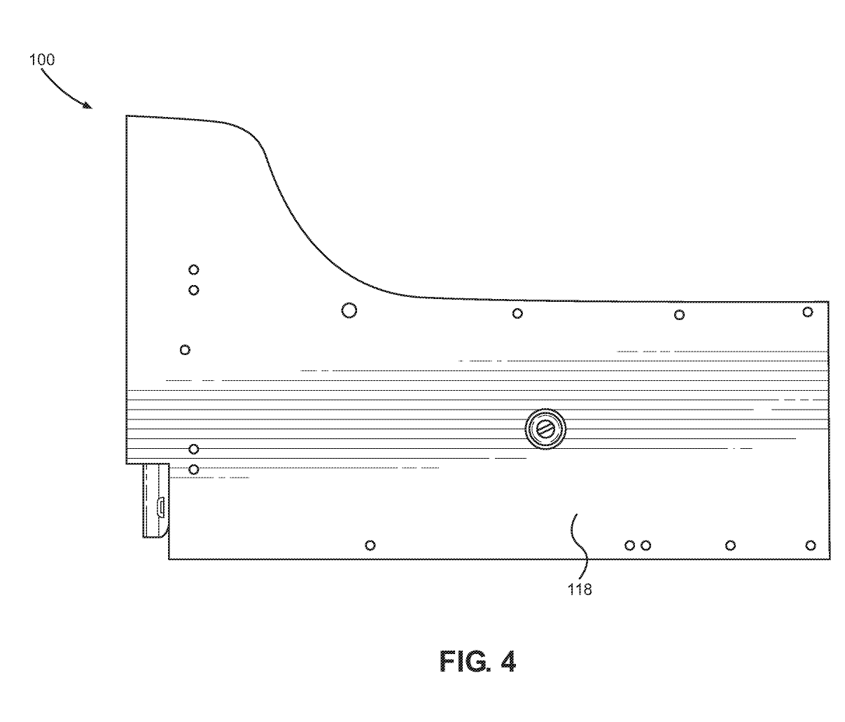

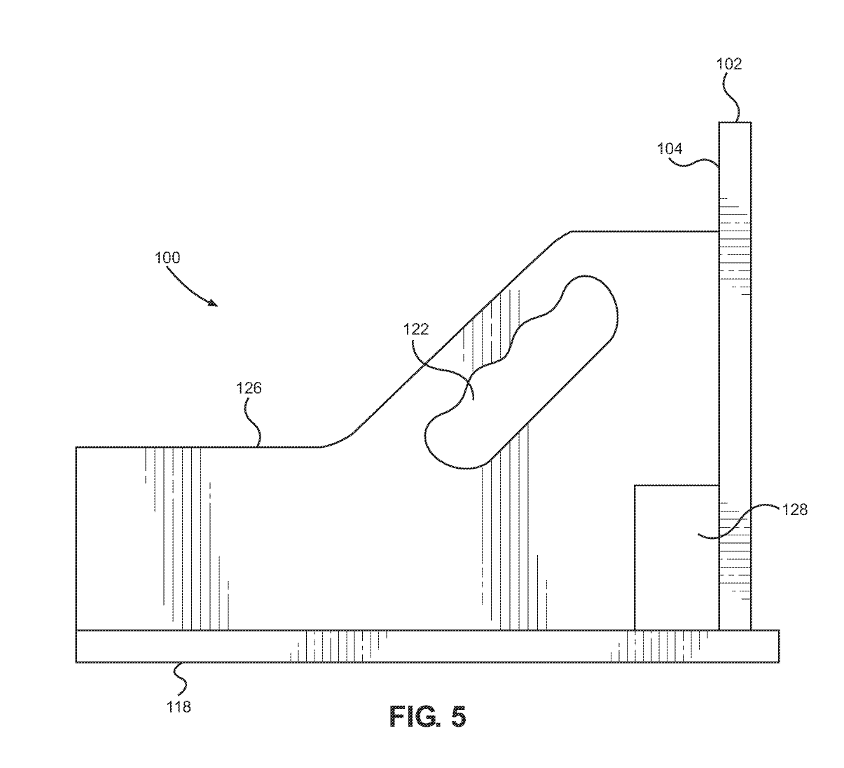

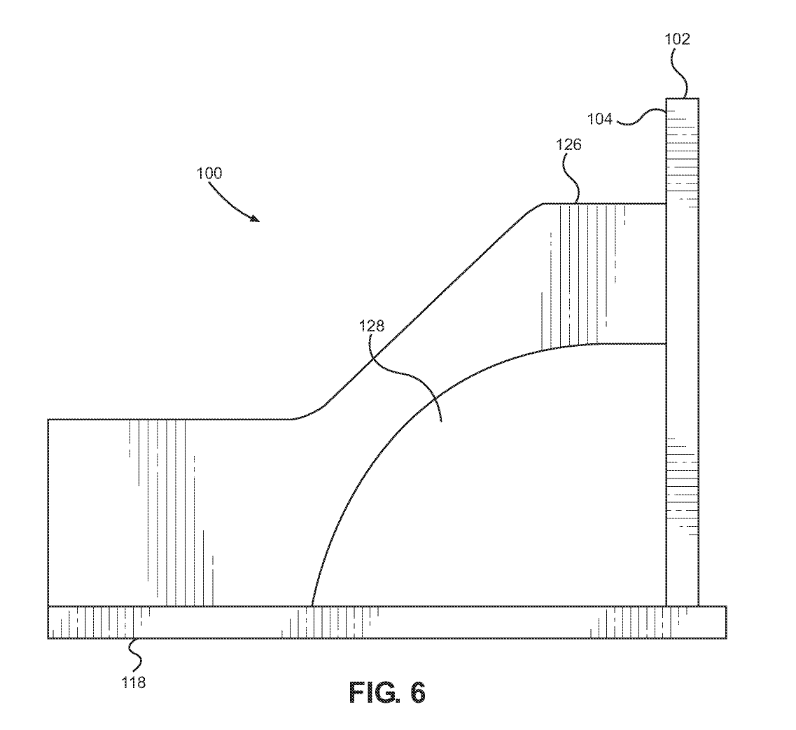

Referring to FIGS. 4-6, there is shown an underside, a right, and a left view of the scope viewing apparatus 100 according to one embodiment of the present disclosure, respectively. Further, the at least one of the opposing arm members 112 comprises at least one aperture 128 extending along a bottom corner of the at least one opposing arm members 112, as shown in FIGS. 5-6. The at least one aperture 128 may be access openings to view various settings of the spotting scope 114, such as to view a magnification dial or focus adjustment dial. For example, when viewing the rear of the scope viewing apparatus 100 as shown in FIG. 3, the left at least one of the opposing arm members 112 may comprise the at least one aperture 128 in the interior corner of the side facing the spotting scope 114. In this first example, the at least one aperture 128 may align with a magnification dial of the spotting scope 114, also shown in FIG. 5. Still referring the rear of the scope viewing apparatus 100 as shown in FIG. 3, for example, the right at least one of the opposing arm members 112 may comprise the at least one aperture 128 in the interior corner of the side facing the spotting scope 114. In this second example, the at least one aperture 128 may align with a focus adjustment dial of the spotting scope 114, also shown in FIG. 6.

Additionally, the scope viewing apparatus 100 further comprises at least one base 118 to which the frame 102 and the opposing arm members 112 attach, as shown in FIGS. 2 and 4-6. The at least one base 118 rests or suspends the scope viewing apparatus 100 on a surface. The at least one base 118 may also have plurality of apertures through which fasteners such as screws fit, as shown in FIG. 4. For example, the opposing arm members 112 and frame 102 may attach to the base via screws. The scope viewing apparatus 100 also comprises at least one brace 126 attached to at least one of the opposing arm members 112, as shown in FIGS. 5-6. The at least one brace 112 runs along the top edge of the opposing arm members 112, as well as the side edge of the opposing arm members 112 not in contact with frame 104.

In order to use the scope viewing apparatus 100, mounting brackets 108 are preliminarily fixed at a set distance compatible to receive the device 116. A user may first slide the device 116 into the channels formed by the synchronizing blocks 110 and mounting brackets 108. Alternatively, a user may first slide the spotting scope 114 in between the opposing arm members 112. Irrespective of whether the device 116 or spotting scope 114 is slid in first, the lens (i.e. lens of eyepiece) of the spotting scope 114 will be in precise alignment with the lens of the device 116. The synchronizing blocks 110 are then adjusted to securely position the device 116 such that it does not move. That is, the opposing arm members 112 are aligned with one another and oriented such that when the spotting scope 114 is positioned therebetween, the lens of the spotting scope 114 is aligned with a center of the lens of the device 116. In this way, scope viewing apparatus 100 provides an enlarged view of the image in the spotting scope 114's view and improves visibility for those who wear glasses or have difficulty looking through the eyepiece of the spotting scope 114.

It is therefore submitted that the instant disclosure has been shown and described in what is considered to be the most practical and preferred embodiments. It is recognized, however, that departures may be made within the scope of the disclosure and that obvious modifications will occur to a person skilled in the art. With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1) A scope viewing apparatus comprising:
a frame comprising a first side and a second side;
the first side of the frame comprising mounting brackets and synchronizing blocks, wherein the synchronizing blocks lay atop the mounting brackets;
the second side of the frame comprising opposing arm members perpendicularly protruding from the second side of the frame, wherein the opposing arm members are configured to receive a spotting scope therebetween;
wherein an interior of the synchronizing blocks is configured to slidably receive a device into an interior of the mounting brackets such that a lens of the device is aligned with an eyepiece of the spotting scope.

2) The scope viewing apparatus of claim 1, further comprising at least one base to which the frame and the opposing arm members are attached.

3) The scope viewing apparatus of claim 1, wherein the synchronizing blocks lay atop the mounting brackets such that the interior of the mounting brackets and the interior of the synchronizing blocks form a channel.

4) The scope viewing apparatus of claim 1, wherein the frame comprises at least one aperture adjacent at least one corner of the frame.

5) The scope viewing apparatus of claim 1, wherein the opposing arm members are mounted to the second side of frame.

6) The scope viewing apparatus of claim 1, wherein the opposing arm members protrude at a perpendicular orientation relative to the mounting brackets.

7) The scope viewing apparatus of claim 1, wherein at least one of the opposing arm members comprises at least one groove.

8) The scope viewing apparatus of claim 1, further comprising at least one brace attached to at least one of the opposing arm members.

9) The scope viewing apparatus of claim 1, wherein at least one of the opposing arm members comprises at least one handle extending along a side of the at least one opposing arm members.

10) The scope viewing apparatus of claim 1, wherein at least one of the opposing arm members comprises at least one aperture extending along a bottom corner of the at least one opposing arm members.

11) A scope viewing apparatus comprising:
a frame comprising a first side and a second side;
the first side of the frame comprising mounting brackets and synchronizing; blocks, wherein the synchronizing blocks lay atop the mounting brackets;
the second side of the frame comprising opposing arm members perpendicularly protruding from the second side of the frame;
a spotting scope disposed between the opposing arm members;
wherein an interior of the synchronizing blocks is configured to slidably receive a device into an interior of the mounting brackets such that a lens of the device is aligned with an eyepiece of the spotting scope.

12) The scope viewing apparatus of claim 11, further comprising at least one base to which the frame and the opposing arm members are attached.

13) The scope viewing apparatus of claim 11, wherein the synchronizing blocks lay atop the mounting brackets such that the interior of the mounting brackets and the interior of the synchronizing blocks form a channel.

14) The scope viewing apparatus of claim 11, wherein the frame comprises at least one aperture adjacent at least one corner of the frame.

15) The scope viewing apparatus of claim 11, wherein the opposing arm members are mounted to the second side of frame.

16) The scope viewing apparatus of claim 11, wherein the opposing arm members protrude at a perpendicular orientation relative to the mounting brackets.

17) The scope viewing apparatus of claim 11, wherein at least one of the opposing arm members comprises at least one groove.

18) The scope viewing apparatus of claim 11, further comprising at least one brace attached to at least one of the opposing arm members.

19) The scope viewing apparatus of claim 11, wherein at least one of the opposing arm members comprises at least one handle extending along a side of the at least one opposing arm members.

20) The scope viewing apparatus of claim 11, wherein the spotting scope comprises at least one magnification dial and at least one focus adjustment dial.
